(19) United States
(12) Patent Application Publication
(10) Pub. No.: US 2026/0065595 A1
(43) Pub. Date: Mar. 5, 2026

(54) METHOD, SYSTEM, AND APPARATUS FOR AUTOMATED SPORTING TROPHY MEASUREMENT AND SCORING

(71) Applicants: Jeremy PURVIS, Highland Village, TX (US); Darren FURR, Highland Village, TX (US)

(72) Inventors: Jeremy PURVIS, Highland Village, TX (US); Darren FURR, Highland Village, TX (US)

(21) Appl. No.: 19/314,959

(22) Filed: Aug. 29, 2025

Related U.S. Application Data
(60) Provisional application No. 63/689,324, filed on Aug. 30, 2024.

(51) Int. Cl. G06T 17/20; G01S 17/89; G06T 7/60

(52) U.S. Cl. CPC G06T 17/20; G01S 17/89; G06T 7/60; G06T 2207/10028; G06T 2210/56

(57) ABSTRACT

An approach is provided for automated sporting trophy measurement and scoring. The approach involves, for instance, acquiring, by a depth sensor of a mobile device, sensor data representing a three-dimensional (3D) point cloud of a trophy animal including an animal feature. The approach also involves detecting, by one or more processors of the mobile device, points of the 3D point cloud corresponding the animal feature, and orienting the animal feature of interest to a designated measurement orientation. The approach further involves building a model of the animal feature comprising a skeleton graph with nodes and edges. The approach further involves computing one or more measurements of the animal feature from the model and the point cloud, and computing a score from the one or more measurements on the mobile device without network connectivity.

### RELATED APPLICATION

This application claims the benefit of priority to U.S. Provisional Patent Application No. 63/689,324, filed Aug. 30, 2024, the contents of which is incorporated by reference herein in its entirety.

### FIELD OF THE INVENTION

The technical field of the invention centers around the measurement and analysis of sporting trophies, e.g., deer antlers (or antlers of other members of the Cervid family of mammals) and fish, using the capabilities of modern smartphones. This field involves the use of technologies like LiDAR and photogrammetry to create 3D point clouds (3DPC) of the trophies for measurement and analysis.

### BACKGROUND

Traditional methods for measuring and scoring sporting trophies such as deer antlers or large fish remain highly manual, time-consuming, and error-prone. Hunters and anglers often rely on physical tools like tape measures and calipers to make trophy measurements before applying complex scoring formulas. These processes can take a significant amount of time, require specialized expertise, and often are impractical in field conditions where time, lighting, and environmental factors limit accuracy.

### SOME EXAMPLE EMBODIMENTS

Therefore, there is a need for automated sporting trophy measurement and scoring.

According to one embodiment, a method comprises acquiring, by the depth sensor of the mobile device, sensor data representing a three-dimensional (3D) point cloud of a trophy animal including an animal feature. The method also comprises detecting, by one or more processors of the mobile device, points of the 3D point cloud corresponding the animal feature. The method further comprises orienting the animal feature of interest to a designated measurement orientation. The method further comprises building a model of the animal feature comprising a skeleton graph with nodes and edges. The method further comprises computing one or more measurements of the animal feature from the model and the point cloud. The method further comprises computing a score from the one or more measurements on the mobile device without network connectivity. The method further comprises presenting a visualization of the score, the one or more measurements, or a combination thereof on a user interface of a display device.

According to another embodiment, an apparatus (e.g., a mobile device equipped with a depth sensor) comprises at least one processor, and at least one memory including computer program code for one or more computer programs, the at least one memory and the computer program code configured to, with the at least one processor, cause, at least in part, the apparatus to acquire, by the depth sensor of the mobile device, sensor data representing a three-dimensional (3D) point cloud of a trophy animal including an animal feature. The apparatus is also caused to detect, by one or more processors of the mobile device, points of the 3D point cloud corresponding the animal feature. The apparatus is further caused to orient the animal feature of interest to a designated measurement orientation. The apparatus is further caused to build a model of the animal feature comprising a skeleton graph with nodes and edges. The apparatus is further caused to compute one or more measurements of the animal feature from the model and the point cloud. The apparatus is further caused to compute a score from the one or more measurements on the mobile device without network connectivity. The apparatus is further caused to present a visualization of the score, the one or more measurements, or a combination thereof on a user interface of a display device.

According to another embodiment, a computer-readable storage medium carries one or more sequences of one or more instructions which, when executed by one or more processors, cause, at least in part, an apparatus to acquire, by the depth sensor of the mobile device, sensor data representing a three-dimensional (3D) point cloud of a trophy animal including an animal feature. The apparatus is also caused to detect, by one or more processors of the mobile device, points of the 3D point cloud corresponding the animal feature. The apparatus is further caused to orient the animal feature of interest to a designated measurement orientation. The apparatus is further caused to build a model of the animal feature comprising a skeleton graph with nodes and edges. The apparatus is further caused to compute one or more measurements of the animal feature from the model and the point cloud. The apparatus is further caused to compute a score from the one or more measurements on the mobile device without network connectivity. The apparatus is further caused to present a visualization of the score, the one or more measurements, or a combination thereof on a user interface of a display device.

According to another embodiment, an apparatus (e.g., a mobile device equipped with a depth sensor) comprises means for acquiring, by the depth sensor of the mobile device, sensor data representing a three-dimensional (3D) point cloud of a trophy animal including an animal feature. The apparatus also comprises means for detecting, by one or more processors of the mobile device, points of the 3D point cloud corresponding the animal feature. The apparatus further comprises means for orienting the animal feature of interest to a designated measurement orientation. The apparatus further comprises means for building a model of the animal feature comprising a skeleton graph with nodes and edges. The apparatus further comprises means for computing one or more measurements of the animal feature from the model and the point cloud. The apparatus further comprises means for computing a score from the one or more measurements on the mobile device without network connectivity. The apparatus further comprises means for presenting a visualization of the score, the one or more measurements, or a combination thereof on a user interface of a display device.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of system for providing automated sporting trophy measurement and scoring, according to one embodiment;

FIG. 2 illustrates an example of a three-dimensional point cloud (3DPC) of a pair of antlers 107, according to one embodiment;

FIG. 3 is a flowchart of a process for constructing a model of a trophy or parts thereof from 3DPC, according to one embodiment;

FIG. 4A illustrates an example of measurements of an antler, according to one example embodiment;

FIG. 4B illustrates example user interfaces for providing automated sporting trophy measurement and scoring, according to one embodiment;

FIG. 5 is a diagram of hardware that can be used to implement an embodiment;

FIG. 6 is a diagram of a chip set that can be used to implement an embodiment; and

FIG. 7 is a diagram of a mobile station (e.g., handset) that can be used to implement an embodiment.

### DESCRIPTION OF PREFERRED EMBODIMENT

Methods, systems, and apparatuses for providing automated sporting trophy measurement and scoring are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “sporting trophy” refers to any animal or parts/features thereof (e.g., antlers, horns, etc.) that are hunted or fished. Although the term “sporting” is used herein, it is contemplated that the animals or parts thereof may be hunted or fished for sport or for sustenance. In addition, it is contemplated that the various embodiments described herein are applicable to the measurement and/or scoring of any animal or animal features (e.g., parts) thereof regardless of whether the animal is hunted or fished.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

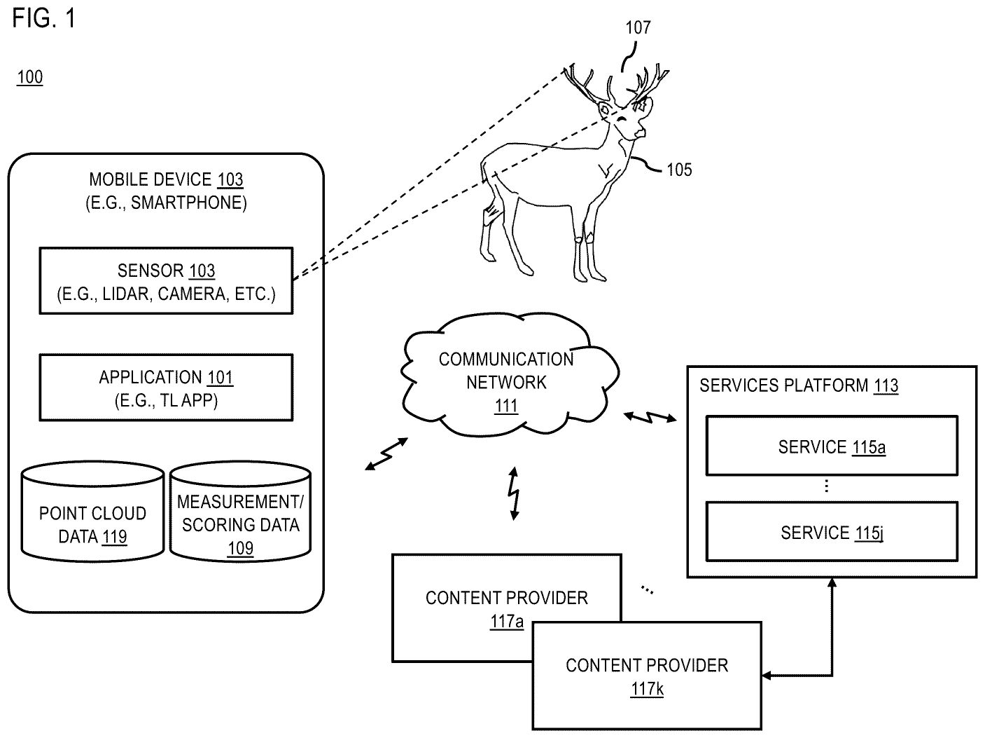

FIG. 1 is a diagram of system 100 for providing automated sporting trophy measurement and scoring, according to one embodiment. In one embodiment, the system 100 includes an application 101 (also referred to as a Trophy Locker (TL) app) executing on a mobile device 103 (e.g., smartphone or any other device or apparatus with equivalent functionality equipped with one or more sensors 104). Examples of the sensors 104 include but are not limited to LiDAR, time-of-flight, camera, and/or any other sensor type capable of generating a point cloud representation of trophy animals 105 and/or their parts. The TL app 101, for instance, can provide deer hunters and fishers (e.g., users of the TL app 101 and/or mobile device 103) with a fast and relatively convenient means of scoring the deer they kill and the fish they catch. As discussed above, the generic term for both or any other animal to be measured or scored herein is a trophy 105.

For deer scoring, hunters often measure all aspects of a deer's antlers 107, including the length of both main beams, all tines protruding therefrom, a predetermined number (e.g., four) circumference measurements at various prescribed points, as well as the distance between various points on either side of the antlers 107. Because it is the nature of deer antlers 107 to curve (in particular the main beam), these measurements are typically manually taken with the use of a tape measure. For example, an American non-profit club called Boone and Crockett (hereinafter “B&C”) has formulated a way of using these measurements to derive an aggregate numeric score for each pair of antlers 107, ranking them according to both size and symmetry. Naturally, the higher the score, the better. B&C measurements are performed to the nearest one-eighth of an inch. Done manually, this process generally takes 20 to 30 minutes to complete. To help the process, B&C offers official forms on which the measurements and scores can be recorded. Submission to their national database requires an affidavit officially witnessed by either a notary public or an officially recognized B&C Measurer.

With respect to fish scoring, quantifying the magnitude of a fish is more straightforward and consists of recording the length and weight of a given fish. A popular means of commemorating the capture of larger fish is to have a replica created by a taxidermist. The replica is not exact, but is based on the painting of the fish's coloration onto a pre-manufactured “blank” that is of the same species and roughly the same size/weight, based on data provided by the fisherman.

However, regardless of type of animal or trophy 105 (e.g., deer, fish, etc.), traditional measurement and scoring processes are generally manual processes that either take a significant amount of time (e.g., 20 or 30 minutes), may require measurers with specialized expertise, and/or are prone to manual measurement errors. As a result, there are significant technical challenges with respect to finding solution to these issues.

These technical challenges are summarized as follows. Accurate, repeatable field scoring of sporting trophies involves capturing numerous prescribed measurements on complex, curved, and branching geometries (e.g., main beams, tines, four circumferences at specified intervals, and various spreads) to at least ⅛-inch precision; performed manually, this process typically consumes a significant amount of time (e.g., 20-30 minutes) and is susceptible to human error and inconsistency. Digital approaches introduce further challenges such as but not limited to the following: generating a sufficiently dense, metrologically reliable 3D point cloud under outdoor conditions (e.g., field conditions); mitigating limitations of photogrammetry workflows that often require dozens of high-resolution images and server-side reconstruction with dependable connectivity; and avoiding bulky, specialized hardware solutions that are impractical for real-time, in-field use. Even with depth sensing, the mobile pipeline must solve technical problems of isolating antlers from background clutter, orienting them into a consistent measurement frame (including left/right disambiguation and base/tip identification), and controlling noise/outliers while meeting device compute/memory constraints to produce timely results without network reliance.

Robust model construction to represent the trophy animal or animal feature presents additional challenges, including selecting and executing an appropriate representation (e.g., skeletonization, volumetric voxelization, or mesh-based methods), extracting lengths, computing circumferences from centerlines by traversing to a reliable point-density boundary, and determining spreads across antlers with adequate accuracy. Practical deployment also requires immediate, on-device scoring, user feedback such as progress indication, and deferred synchronization to cloud services when connectivity permits. For fish, additional challenges arise in measuring length along surface curvature and girth at the widest point (excluding fins) to support weight estimation, again under variable field conditions and without server dependence.

To address these technical challenges, the system 100 of FIG. introduces a capability to greatly streamline the capture of the measurements and scoring data 109 as discussed above, using nothing more than the native capabilities of certain smartphones (e.g., mobile devices 103), and not requiring immediate Internet connectivity (e.g., over a communication network 111) or access to a remote server (e.g., a services platform 113, one or more services 115a-115j of the services platform 113, and/or one or more content providers 117a-117k) in order to perform the scanning (e.g., capturing point cloud data 119 representing the trophy 105 or its antlers 107), the measuring of the scan, or its scoring.

By way of example, it is anticipated that scanning and scoring can happen in the following real-world contexts including but not limited to:
1. Hunters who have paid taxidermists to preserve a wall mount of a trophy/pair of antlers but who have not gone to the trouble of scoring said trophy will naturally be curious to quickly and easily do so in the comfort of their own home.
2. Hunters who are in the field, actively hunting, will want to score any trophies they kill immediately thereafter, before even repatriating the trophy to a taxidermist, either before or after field dressing it.
3. Fishermen who use the catch-and-release method of fishing will want to quickly scan the dimensions of a fish before releasing it back into the water, either for digital commemoration or for the eventual production of a replica.

In one embodiment, the application 101 alone or in combination with the services platform 113, services 115, and/or content providers 117 (e.g., when Internet connectivity is available) can provide for various services, functions, and/or applications based on the acquired measurement/scoring data 109. These services, functions, and/or applications include but are not limited to:
1. Compiling a Virtual Gallery: In one embodiment, all scans, scores, and photos taken of a given deer, fish, or any other trophy 105 can be stored along with metadata such as date, location, companions, notes, etc. for later review. For example, the 3D scans (e.g., point cloud data 119) used to calculate scores (e.g., measurement/scoring data 109) would remain an artifact that the user could access at a later date, with the ability to spin and zoom the scan for later review.
2. Social Media Sharing: In one embodiment, the TL app 101 can provide links to post scores and photos to popular social media sites such as Facebook and Instagram, as well as “internally” with other users of the TL app 101 (e.g., via connectivity to the services platform 113, services 115, and/or content providers 117).
3. User Profile: In another embodiment, the system 100 (e.g., via the application 101) can have a basic user profile section. In one embodiment, the user profile section can include as little data as possible such as but not limited to: username, first and last name, city and state of residence, user profile photo, and/or possibly age or birthday.

In one embodiment, the application 101 and/or any other component of the system 100 can include components for acquiring a 3D Point Cloud representation (e.g., point cloud data 119) of a trophy 105 or parts thereof (e.g., antlers 107). As used herein, a 3D Point Cloud is a collection of data points in a three-dimensional coordinate system. Each point represents a specific location in space corresponding to a location on the surface of the trophy 105 or parts thereof. In this way, the points of the 3D Point Cloud can provide a detailed representation of the 3D geometry of the trophy 105 or parts thereof. The detail or level of resolution can depend on the density of the points in the 3D point cloud.

Performing measurements of physically complex objects (e.g., trophies 105) by way of digital tools involves working with a three-dimensional point cloud (3DPC) of some kind. It is contemplated that any digital tool or process known in the art can be used according to the various embodiments described herein to generate the 3DPC. For example, “Augmented Reality” (AR) tools such as Google Measure can approximate the measurement of a distance between two linear points using a smartphone's 2D camera, but a pair of antlers 107 curving in multiple directions through space generally surpasses what currently available two-dimensional AR tools can handle. Conversely, a 3DPC is an accumulation of vertices, which is to say points with X, Y, Z coordinates relative to the measurement tool. The “density” of a 3DPC refers to the quantity of vertices accumulated of a given object. If a 3DPC is sufficiently dense, then even very physically complex objects (e.g., trophies 105, antlers 107, etc.) can be replicated digitally for further analysis.

In one embodiment, the system 100 can use means such as but not limited to photogrammetry and time-based scanning to accumulate 3DPCs of trophies 105 or parts thereof. For example, Photogrammetry is a technique that takes multiple 2D photographs of a given object and “stitches” them together, using the smartphone's (e.g., mobile device 103) movement through space (as quantified by way of its accelerometer and gyroscopic sensors) to assemble a “mesh” that has three-dimensional properties. The vertices ascertained are relatively sparse and are connected together in triangles that are overlaid with photographic segments to produce the appearance of a surface known as a mesh.

One benefit of photogrammetry is that it can be executed using any modern smartphone (e.g., mobile device 103) with a camera having moderate resolution, provided that enough photos of sufficient resolution are captured. One challenge with photogrammetry is that the systemic resources for assembling a 3DPC of sufficient density (e.g., dense enough to accurately measure the features of trophies 105 or parts thereof) can be potentially significant and can surpass what would be considered “quick and easy” by an average smartphone user. For example, most photogrammetry apps available today (even those that do not seek to perform measurements) require the capture of dozens of high-resolution photos, which are then uploaded to a remote server for processing. This can potentially exclude photogrammetry as an acceptable solution for someone seeking to obtain measurements and a score in under three to five minutes, especially in a natural setting where there will often be little-to-no Internet connectivity.

Another example means for acquiring 3DPC are depth sensors (e.g., using time-based scanning). By way of example, there are at least two technologies herein, ToF (Time of Flight) and LiDAR (Light Detection and Ranging). Both technologies consist of a sensor emitting light pulses and measuring the amount of time required for the reflections to be captured by the sensor.

With a LiDAR scanner, an extremely dense 3DPC can be acquired in very little time with compute resources that are readily available in modern smartphones (and not requiring specialized hardware). Thus, TL app 101 can be executed on mobile devices 103 that are equipped with sufficient compute resources to generate high resolution 3DPC (e.g., resolution sufficient to measure trophies 105 at accuracy and precision levels to support scoring, such as one eighth inch used for B&C scoring) using, for instance, time-based scanning, photogrammetry, and/or any other equivalent technology. In this way, the application 101 will be engineered in such a way as to be quickly adapted for any devices that feature ToF or LiDAR sensors, cameras for photogrammetry, and/or any other equivalent scanning technology.

It is contemplated that other means of capturing a representation (e.g., 3D representation of the trophy 105) can be used including but not limited to Computerized Axial Tomography (CAT) scans, and range finders. For example, a CAT scan can be used to obtain multiple “slices” of three-dimensional x-ray scans. These “slices” are assembled to produce a wholistic 3D image. While CAT scans may currently be impractical to use in the field based on cost and size of equipment, it is contemplated that as miniaturized versions of CAT scan equipment is developed, such technology can be applied according to the various embodiments described herein.

With respect to Range Finders, this approach posits the analysis of regular two-dimensional images on the basis of a known reference object (KRO), in this case a distanced measurement provided by the camera's range finder. For example, the user can take multiple images of the trophy 105 from different angles and distances using the camera. For each image, the camera's range finder can provide the distance between the camera and the object, which can be used as a reference point. The application 101 can then use a technique called triangulation to estimate the 3D coordinates of the points on the trophy 105's surface. Triangulation is a process of finding the location of a point by measuring the angles between the point and two known points. In this case, the known points are the camera's position and the reference point provided by the range finder. By applying trigonometry, the application 101 can calculate the third angle and the length of the sides of the triangle formed by the three points, and thus determine the 3D coordinates of the point on the trophy 105. The application 101 can repeat this process for all the points in the images and combine them into a 3DPC of the trophy 105.

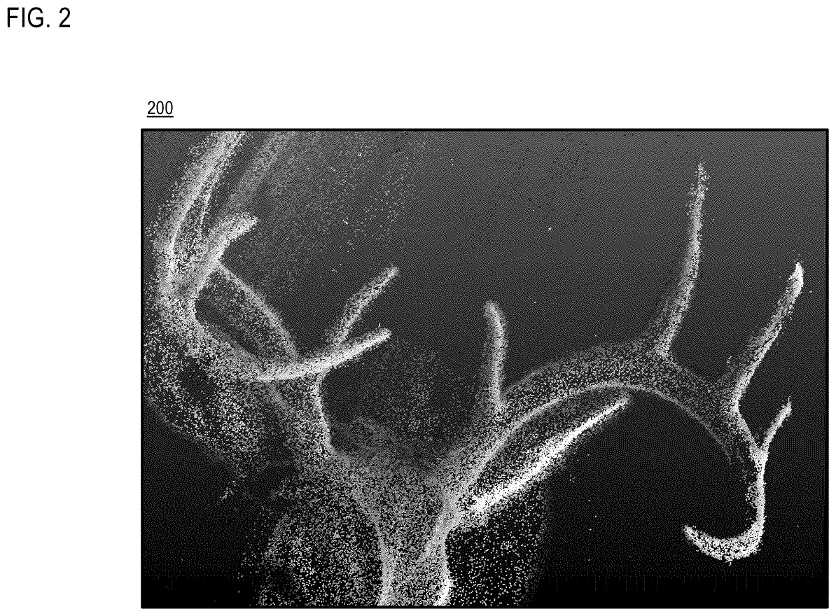

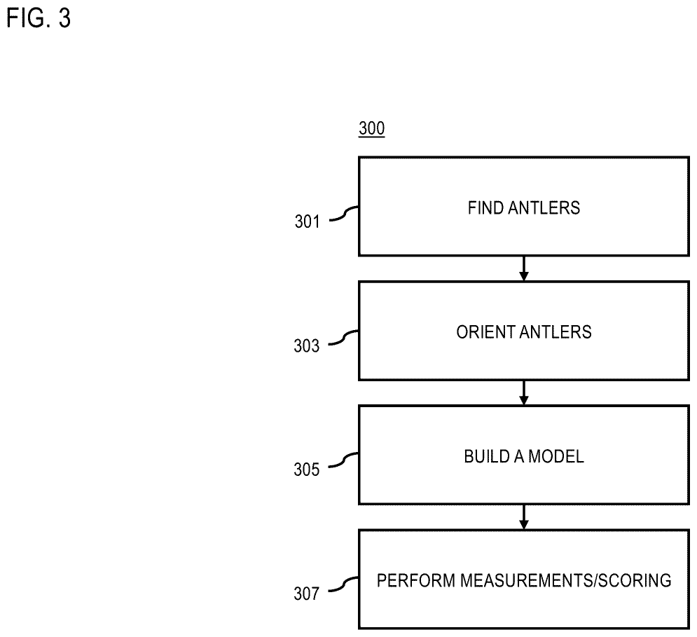

FIG. 2 illustrates an example 200 of a 3DPC 201 of a pair of antlers, according to one embodiment. A raw 3DPC 201 consists of a collection of points in 3D space. As such, a computer program (e.g., application 101) can view the point cloud data 119 as unstructured, e.g., as a random listing of vertices or points with no apparent relationship to one another. Thus, in one embodiment, the application 101 can perform pre-processing steps to construct a model from the raw point cloud data 119 (e.g., as illustrated in FIG. 3). By way of example, a “model” refers to a digital representation of a trophy or its components (e.g., antlers) constructed from a three-dimensional point cloud. This model organizes the collected spatial data points into a structured format, such as a mesh, skeleton, or volumetric grid, enabling further analysis, measurements, and scoring of the object's physical characteristics.

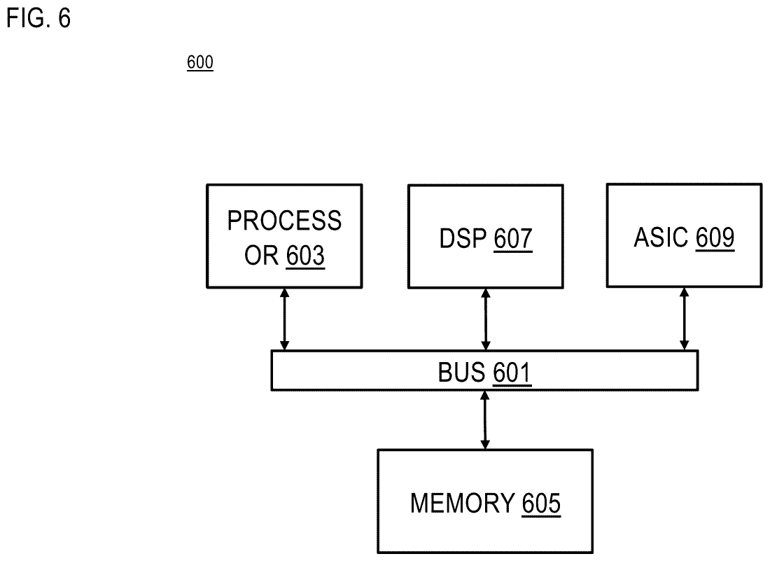

FIG. 3 is a flowchart of a process for constructing a model of a trophy 105 or parts thereof from 3DPC, according to one embodiment. In various embodiments, the application 101 may perform one or more portions of the process 300 and may be implemented in, for instance, a chip set including a processor and a memory as shown in FIG. 6 or in circuitry, hardware, firmware, software, or in any combination thereof. As such, the application 101 and/or any of its components can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the application 101 finds the trophy 105 and/or parts thereof (antlers 107) of interest in the 3DPC. In one embodiment, the process begins with acquiring sensor data representing a three-dimensional (3D) point cloud of a trophy animal including an animal feature. In one embodiment, the mobile device 103's sensor 104 (e.g., a depth sensor such as but not limited to an integrated time-of-flight (ToF) or LiDAR depth sensor) emits light pulses and measures their return time to generate a dense 3D point cloud of the trophy or its antlers. This acquisition can occur entirely on-device without requiring network connectivity, enabling real-time scanning in outdoor environments. Alternatively, the point cloud can be constructed through photogrammetry, where the device captures multiple two-dimensional images from different angles and uses onboard processing to stitch them into a 3D representation. Another option includes range-finder triangulation, in which the device's camera and distance sensor capture positional data to estimate 3D coordinates of surface points. These methods may be used individually or in combination to ensure sufficient point density and accuracy for subsequent modeling and measurement steps.

It is noted that while the various embodiments are discussed mainly with depth sensors, it is contemplated that the various embodiments may use any number of 3D acquisition modalities so that sensor data representing a point cloud of a trophy animal 105 (e.g., antlers or fish) can be obtained even when any single modality is impaired. In primary embodiments, the mobile device 103's integrated time-of-flight/LiDAR depth sensor 104 generates a dense 3D point cloud entirely on-device, enabling rapid, connectivity-independent capture suitable for outdoor use where bandwidth may be limited. In alternative embodiments, photogrammetry reconstructs a 3D representation from a bounded set of images when the depth sensor is unavailable, and range-finder triangulation estimates 3D coordinates from camera imagery and distance readings; these alternatives expand device compatibility and maintain acquisition robustness under conditions such as reflective surfaces, partial occlusions, or depth sensor degradation. The system can select or combine modalities to achieve sufficient point density for downstream modeling and measurement, meet accuracy targets customary in the field (e.g., on the order of one-eighth inch for scoring), and satisfy mobile compute/memory constraints while deferring any cloud synchronization until connectivity is available. In this way, the 3DPC of a trophy animal 105 and/or its parts can be acquired.

Although it can be clear to the human eye and brain when looking at the 3DPC represented in FIG. 2 which point concentrations represent antlers 107, this is not readily apparent to computer code. Thus, in one embodiment, the system excludes all non-antler points (or any points not part of the animal feature of interest), and/or identify which groupings constitute antlers 107 or animal feature of interest. In one embodiment, this can be done manually by having the user of the app zoom in on only the antlers and then use point-and-click tools to cut out or exclude irrelevant groupings of point. For example, the application 101 may present an interactive interface that allows the user to identify one or more burr or base regions corresponding to the origin points of the left and/or right antlers. Upon receiving these user inputs, the system associates the indicated regions with corresponding clusters of point cloud data and uses their spatial relationship as anchor points for subsequent classification. Branches extending from each identified base region are then analyzed for geometric continuity and curvature, enabling the system to label the primary branch as the main beam and to classify secondary offshoots as tines based on proximity to the base and relative branching angle. This approach leverages user-provided anatomical cues to disambiguate complex or noisy scans, reduce false positives from background objects, and accelerate segmentation by constraining the search space for feature attribution. The resulting labeled structure serves as the foundation for orientation, model construction, and measurement operations described herein.

In addition or alternatively, the application 101 can simplify this step for the user by using machine learning to derive a template of certain types of antlers and “finding” them within the scan. For example, the application 101 can train a neural network model to classify the points in the 3DPC as an antler point or a non-antler point based on features such as curvature, density, and distance. The application 101 can use supervised learning to train the model on labeled data, such as existing 3DPCs of antlers with annotated points, or use unsupervised learning to train the model on unlabeled data, such as raw 3DPCs of antlers, and cluster the points into different categories based on similarity. The application 101 can then apply the trained model to new 3DPCs of antlers and assign labels or clusters to the points accordingly. Alternatively, in other embodiments, the application 101 can use multi-modal large language models (LLMs) to perform equivalent classification of the 3DPCs.

In step 303, the application can then orient the detected antlers or animal features of interest in the 3DPC to align the antlers with a predefined coordinate system (or otherwise orient the animal feature of interest to a designated measurement orientation). For example, even simply knowing which points constitute the antlers 107 or other parts of interest, it may still be necessary for the computer code to recognize left from right, and the base of the antlers from the tips. Again, in one embodiment, this can be done manually by having the app user spin the 3DPC within a static grid until it is oriented on a vertical and horizontal axis to a designated measurement orientation (e.g., antlers facing the user or any other specified orientation). In addition or alternatively, the application 101 can use machine learning to execute both the orientation and the identification of the antlers 107 as described above to rotate or translate the 3DPC until it is oriented correctly for measurement.

In step 305, the application 101 can use the detected antlers 107 and/or animal feature of interest in the designated orientation to build a model of the antlers 107 or other parts of interest. Building a model, for instance, refers to grouping of points into sequential segments that can subsequently be analyzed for measurements and scoring. The grouping of the points can be done via various methodologies such as but not limited to:
1. A volumetric approach assumes orienting the 3DPC within a three-dimensional grid, which is itself divided into fixed increments and using that digital context to perform measurements. In various embodiments of this this approach, the 3DPC is first oriented within a predefined three-dimensional grid or voxel space, the grid being divided into fixed increments (e.g., uniform cubic cells). Each voxel is assigned occupancy values based on the presence of point cloud data, thereby converting an unstructured set of points into a structured volumetric representation. This digital context enables efficient computation of spatial metrics such as volume, cross-sectional area, and local density, which can be used for identifying anatomical features. For example, antler beams and tines can be detected by analyzing contiguous voxel clusters that exhibit elongated, branching geometries above a density threshold, while the burr or base region can be inferred from a high-density cluster at the origin of multiple branches. Similarly, volumetric segmentation can distinguish main beams from tines by comparing voxelized segment lengths and diameters, and can compute circumferences by aggregating voxel layers around a centerline. This structured grid also supports orientation normalization and symmetry analysis, allowing the system to validate left/right antler alignment and detect atypical formations. The volumetric method thus provides a framework for feature extraction under noisy or incomplete scans, complementing alternative modeling techniques such as skeletonization or mesh-based pathfinding.
2. Skeletonization assumes finding the centerpoint of a group of vertices as a means of constructing a “skeleton” or three-dimensional, linear representation of the 3DPC's internal skeleton. Then a segmentation algorithm (e.g., machine learning based segmentation) can be used on the skeletonized representation to follow along the skeleton to organize it into various sequential segments (e.g., corresponding to beams and tines of antlers 107) that can be analyzed.

For example, the system can construct a skeleton graph as an abstract representation of the animal feature model derived from a three-dimensional point cloud. The skeleton graph comprises nodes and edges arranged to capture the topology of the scanned structure while omitting extraneous surface detail. Each node corresponds to a significant geometric event (e.g., such as a branch point, curvature inflection, or terminal tip) while each edge represents a continuous segment between such events, preserving the spatial relationships and connectivity inherent in the original object. This graph-based abstraction enables efficient computation of lengths, angles, and connectivity patterns without requiring full mesh traversal or volumetric analysis.

When applied to antlers, the skeleton graph models the main beam as a primary path extending from a base node (e.g., the burr region) to a terminal tip node, with branch tines represented as secondary edges emanating from intermediate nodes along the main beam. Each tine edge terminates at its own tip node, and the graph structure maintains parent-child relationships that reflect the anatomical hierarchy of the antler. This representation allows the system to compute main beam length by summing edge lengths along the primary path, measure individual tine lengths along their respective edges, and identify prescribed locations for circumference measurements relative to node positions. By encoding the antler geometry as a skeleton graph, the system achieves feature identification and measurement even under noisy or partially occluded point cloud conditions, while reducing computational complexity compared to full-surface modeling.
3. A third approach is to construct a mesh from the 3DPC and to use a pathfinder algorithm to measure a line along the surface of the mesh. In one embodiment, the mesh may be generated by triangulating the point cloud into a representation that approximates the outer surface of the object. Once the mesh is constructed, a pathfinder algorithm (e.g., such as a geodesic shortest-path computation) is applied along the mesh surface to measure distances that follow the true curvature of the feature being analyzed. For example, the algorithm can trace a continuous path along the outer surface of an antler's main beam or a tine from its base to its tip, thereby producing a length measurement that reflects the actual contour rather than a straight-line approximation. This approach can also be extended to compute circumferential measurements by extracting local cross-sections of the mesh and determining perimeters along those sections. The mesh-based method provides an alternative to skeletonization or volumetric techniques and is particularly advantageous when high-fidelity surface detail is available, enabling accurate measurements for irregular or atypical geometries.

In step 307, the application 101 uses the constructed model and/or corresponding point cloud to perform measurements and/or scoring of the trophy 105 or parts thereof. In one embodiment, the application 101 can use the model (e.g., whether by skeletonization, volumetric segmentation, or mesh-based representation) to perform measurements. This approach in conjunction with automated segmentation allows for a centerline measurement of the 3DPC to determine the various lengths involved. Also, it allows for the algorithmic identification of the various points at which the circumference of the antlers are to be measured.

In one embodiment, with respect to skeletonization, this can be done by measuring from the skeletonized centerline outwards, until the density of the 3DPC becomes sparse enough to constitute the outer edge of the antler. For example, the algorithm identifies a path from the base node of the main beam to its terminal node and sums the lengths of all connected edges along this path to determine the main beam length. Similarly, each tine is measured by following its respective branch from the junction node to its tip node.

In one embodiment, another approach to measure the trophy antlers 107 is to use the volumetric displacement method. This method involves calculating the volume of the 3D model constructed from the 3D point cloud, and comparing it to the volume of a reference object with known dimensions. The reference object can be a cube, a sphere, or any other shape that can be easily measured. The ratio of the volumes can then be used to estimate the size and shape of the antlers. For example, if the volume of the 3D model is twice the volume of a reference cube with a side length of 10 cm, then the antlers can be approximated as having a length of 20 cm and a width of 20 cm. This method can also account for the curvature and branching of the antlers by using more complex reference shapes or by dividing the 3D model into smaller segments and comparing them individually.

In yet another embodiment, the application 101 leverages the mesh topology to compute measurements that accurately follow the object's true geometry by applying, for instance, a geodesic pathfinding algorithm or equivalent to determine the shortest path along the mesh service between the base and tip of a main beam or tine.

It is contemplated that once the application 101 has performed its measurements, the application 101 can use any algorithm to score the antlers 107 based on size, symmetry, and/or any other selected characteristics. One possible method of scoring the antlers based on the measurements obtained by the application 101 involves assigning points to various aspects of the antler size and symmetry, such as the length of the main beams, the number and length of the points, the spread between the beams, and the circumference at various locations along each beam. The total score is calculated by adding the points from each category and subtracting any deductions for asymmetry between the left and right antlers. The higher the score, the more impressive the trophy 105 in terms of size and symmetry.

In one embodiment, when measuring antler 107 or similar parts, there are at least three types of measurements that are taken (note that all of these have are made at a designated level of accuracy such as but not limited to the nearest eighth of an inch, the nearest 3 mm increment to provide for sufficient density of the 3DPC for scoring, or an accuracy achievable using equivalent current or developing technologies). The first type of measurement is Length. These are done on both the left and right antlers. The main, longest, central portion of each antler is referred to as the main beam. This is measured in its entirety, from the base of the horns to their furthest tip, along its entire length, following the curvature of the horn, along the outermost surface. The smaller horns that protrude from the main beam are called tines. Each of these is similarly measured, based to tip, inclusive of any curvature, though these tend to be straighter. A typical whitetail deer will have only three tines per antler.

The second type of measurement is Circumference. For both antlers, there are typically four circumference measurements taken: (1) at the smallest place between the base and the first tine; (2) at the smallest place between the first and second tine; (3) at the smallest place between the second and third tine; and (4) at the smallest place between the third and fourth tine. In one embodiment, the application 101 determines one or more circumference measurements by operating on a model that provides a centerline of the trophy feature (e.g., a skeletonized main beam or tine). At each prescribed station (e.g., between the base and first tine, between successive tines), the application 101 defines a local cross-sectional plane orthogonal to the centerline tangent and radially samples outward from the centerline across multiple angular directions. Along each radial sample, the system traverses the associated point-cloud voxels or neighborhoods and detects the outer surface boundary at the first location where either (i) local point occupancy or kernel-estimated point density falls below a configured minimum, or (ii) a density gradient exceeds a threshold indicative of a transition from surface points to background. The distance from the centerline to the detected boundary is taken as a local radius; a circumference value for the station is then computed by (a) aggregating radii across angles or (b) forming a 2D boundary polygon from the sampled boundary points in the cross-sectional plane and summing its perimeter to accommodate non-circular sections. Outlier rejection (e.g., minimum inlier count per angle, angular continuity checks) and optional smoothing of boundary samples may be applied, together with quality checks that set a minimum local point-density to accept a circumference result. This procedure can be implemented entirely on-device and is compatible with alternative models by substituting the point-cloud boundary with a mesh-derived cross-sectional contour or a voxel isosurface at the same stations.

The third type of measurement is Width. This measures the various possible widths between the two antlers such as but not limited to: (1) tip-to-tip measures the distance between the tips (ends) of the two main beams; (2) widest point measures the widest possible distance between the outermost edge of the two main beams; and (3) the inside spread of main beams is measured at a right angle to the center line of the skull at the widest point between main beams. In one embodiment, the application 101 determines one or more width measurements of the trophy by analyzing the modeled geometry of the antlers in conjunction with the underlying point cloud. These width measurements include, but are not limited to: (i) an inside spread of main beams, computed as the shortest distance between the inner surfaces of the left and right main beams measured along a plane orthogonal to the skull centerline; (ii) a tip-to-tip distance, determined by identifying the distal endpoints of the main beams and calculating the linear distance between those tips; and (iii) a widest-point distance, which represents the maximum separation between any two points on the outer surfaces of the main beams. The application 101 may compute these values by projecting candidate points onto a common reference plane, applying geometric constraints to ensure alignment with the antler orientation established during the modeling stage, and selecting the appropriate pair of points based on the measurement definition. These computations can be performed using either the skeletonized centerline model, by referencing node positions corresponding to beam tips, or a surface mesh representation, by sampling surface vertices to identify extremal points, and/or the like.

In one embodiment, the resulting width measurements are then incorporated into the overall scoring algorithm along with length and circumference values to produce a comprehensive trophy score. For example, the application 101 transforms the measured attributes of the modeled trophy (e.g., main-beam length, tine lengths, prescribed circumferences, and width measures such as inside spread, tip-to-tip, and widest-point) into a single trophy score by programmatically combining the measurements in accordance with established scoring conventions and applying asymmetry deductions between left and right antlers where appropriate. In one embodiment, all computations are executed entirely on the mobile device to deliver an immediate, field-usable result without reliance on network connectivity. The resulting score may be accompanied by a per-component breakdown (e.g., lengths, circumferences, widths/spreads) derived from the curated 3D point-cloud/model pipeline (e.g., find→orient→model→measure→score), thereby enabling consistent, repeatable outcomes at accuracy levels customary in the art.

In one embodiment, the score is then presented to the user and persisted with associated artifacts (e.g., such as the 3D scan/model, photos, and trophy metadata (date, location, notes)) in a gallery for later review, comparison, and sharing. Uploads of this information may be queued for deferred synchronization based on connectivity preferences. In certain embodiments, the application 101 can populate standardized scoring forms (e.g., forms used by recognized organizations) and, if desired, facilitate exporting or submitting score information in accordance with applicable procedures. In addition, the application 101 supports social media sharing and in-app sharing of scores and visualizations. The score can further drive practical workflows such as cataloging, tracking, and comparing multiple trophies within a user's account, enabling referrals to affiliated taxidermists or related service providers, and supporting guides or outfitters who require rapid, repeatable, and transportable scoring in the field.

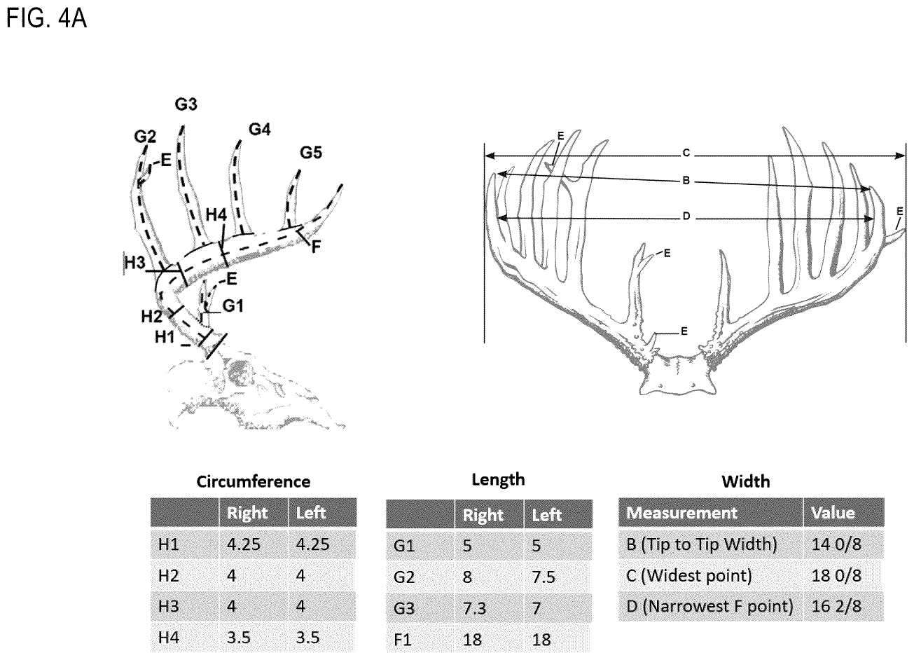

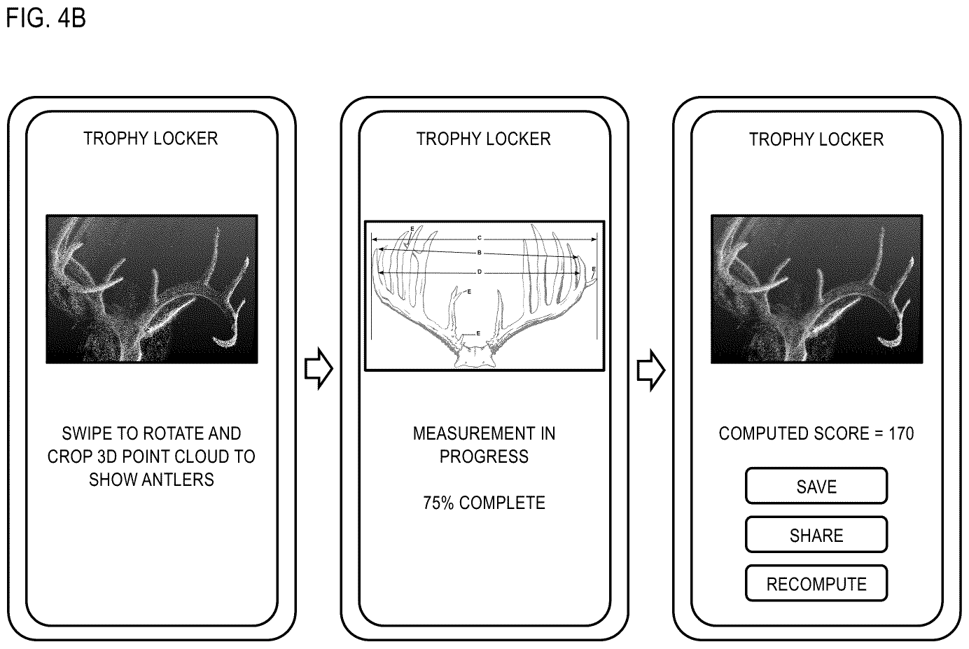

FIG. 4A illustrates an example of measurements of an antler 107, according to one example embodiment. The trophy depiction 401 shows a modeled antler with length-measurement traces following the curvature of the main beam and representative tines (e.g., marked as G1-G5), together with circumference stations H1-H4 positioned at the prescribed locations along the beam between successive tine junctions. Other antler locations are marked as E and F. The trophy depiction 403 shows width measurements computed between the left and right antlers, including B (tip-to-tip distance), C (widest-point distance), and D (inside spread), each referenced to a common orientation frame established during modeling. Exemplary tabular entries beneath the illustrations list right/left values for the circumference 405 stations (H1-H4), for selected length 407 segments (e.g., main beam and tines), and for the width 409 metrics (B-D), demonstrating how the system aggregates these categories into inputs for scoring. This figure is consistent with the disclosure that measurements include main-beam and tine lengths, four circumferences taken at prescribed intervals, and multiple width determinations (inside spread, tip-to-tip, widest point), all derived from the 3D model/point-cloud pipeline described herein.

FIG. 4B illustrates example user interfaces (UIs) 421-425 for providing automated sporting trophy measurement and scoring, according to one embodiment. UI 421 presents a 3D point cloud rendering of antlers with an instruction prompt, “SWIPE TO ROTATE AND CROP 3D POINT CLOUD TO SHOW ANTLERS,” enabling the user to manipulate the scan for optimal visibility and isolation of relevant features (e.g., to place the 3D point cloud into a designated measurement orientation). UI 423 depicts a resulting model of the antlers with overlaid measurement indicators and a progress status reading “MEASUREMENT IN PROGRESS” and indicating that the measurement in “75% COMPLETE,” signifying that the system is actively computing length, circumference, and width metrics from the processed model. UI 425 displays a finalized result with a “COMPUTED SCORE=170” prominently shown, along with actionable controls labeled “SAVE,” “SHARE,” and “RECOMPUTE,” allowing the user to store the result locally, distribute it via social or in-app channels, or initiate recalculation as needed. Collectively, these UIs 421-423 demonstrate an embodiment of the disclosed workflow for guiding the user through scan manipulation, automated measurement, and score presentation within a single, on-device environment.

Although the various embodiments described herein are discussed with the example of deer antlers as trophies 105, it is contemplated that the various embodiments described herein are applicable to type of animal. For example, fish scores typically capture two key measurements. These two measurements can be used to estimate the weight for any fish. The first is length from the front of the mouth to the tip of the tail. This can be difficult if the fish is not holding its tail straight. In that case, the length would be measured by following the length along the surface of the fish. The second is the girth or circumference of the fish at the widest point. The circumference tracks the main part of the body and does not consider the fins.

In summary, according to various embodiments, the present invention include a method, apparatus, computer program product, non-transitory computer readable storage medium, and system for performing any combination of subset of the steps such as but not limited to the following (not all steps need to be performed and the steps can be performed in any order):
(1) Leverage a mobile device (smartphone, tablet, etc.) to collect a 3D point cloud and photo imaging of sporting trophies. Point cloud may be collected through multiple technologies including LiDAR, Time of Flight, and Photogrammetry, either independently or in concert with one another.
(2) Identify and isolate the sporting trophy within the 3DPC.
(3) Orient the relevant features/structure of the trophy, for example programmatically identify its base and differentiate left from right on any symmetrical features.
(4) Programmatically eliminate or disregard any noise in the 3DPC that might distort any subsequent measurements.
(5) Translate 3DPC into a model of the trophy, capturing critical features and segments of the model. Skeletonization is one of the methods used to construct a model of the trophy.
(6) Leverage model and application algorithms to determine key trophy characteristics (species, typical or non-typical, etc.).
(7) Where scan data is lacking or 3DPC vertices are insufficiently dense, leverage historical antler data and statistical modeling to estimate measurements.
(8) Once the model is complete, the application 101 can use developed rules and unique measurement techniques including volumetric and skeletonization methods to capture trophy measurements.
(9) Calculations will be completed entirely on the mobile device without requiring an external computer or server and without any Internet/network connectivity for initial results.
(10) The user interface around these programmatic operations will retain user engagement by displaying a realistic completion timeline and progress towards it (see FIG. 4B for example user interfaces, according to one embodiment).
(11) The resulting model will output a 3D interactive photorealistic view of the trophy to be displayed to the user on mobile devices, which the user can manipulate (e.g., magnifying and/or rotating) using pinching and swiping motions on the touchscreen of the mobile device.
(12) The application 101 can queue and manage upload of all scan data to the cloud based on the availability of network (e.g., wireless) connectivity, with the application 101 giving the user the option as to whether uploads occur only on Wi-Fi or via cellular wireless connectivity.
(13) Scan results can also be available by way of online portal.
(14) Along with 3D view, the application 101 can display several key attributes of the trophy:
(15) Total scoring for Trophy using a variety of attributes: (a) key measurements; and (b) comparison of key features against available data.
(16) In addition to collecting 3DPC, user can input various trophy attributes (e.g., date harvested, location harvested, method of capture, etc.) via the application.
(17) The application 101 can enable user social functions to share the user's trophy and interact with the trophies of others. This includes sharing key outputs like 3D model and scores on social media platforms.
(18) The application 101 can also include sharing/view relevant features of trophies within the application itself.
(19) The application 101 can leverage machine learning (including available LLMs) to enhance scan accuracy by repatriating all scans, models, and user inputs and feedback and using all collected data to continuously refine any algorithms relevant to the processing of the 3DPC.
(20) The application 101 can provide for export of 3DPC to facilitate printing of 2D/3D recreations of the trophy.
(21) The application 101 can allow advanced users to catalog, track and compare multiple trophies, both within their own user account and internally across the platform.

By way of example, the components and circuitry described herein communicate with each other and other components of the communication network using well known, new or still developing protocols. In this context, a protocol includes a set of rules defining how the network nodes within the communication network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application headers (layer 5, layer 6 and layer 7) as defined by the OSI Reference Model.

The processes described herein for providing automated sporting trophy measurement and scoring may be advantageously implemented via circuitry, software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

As used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

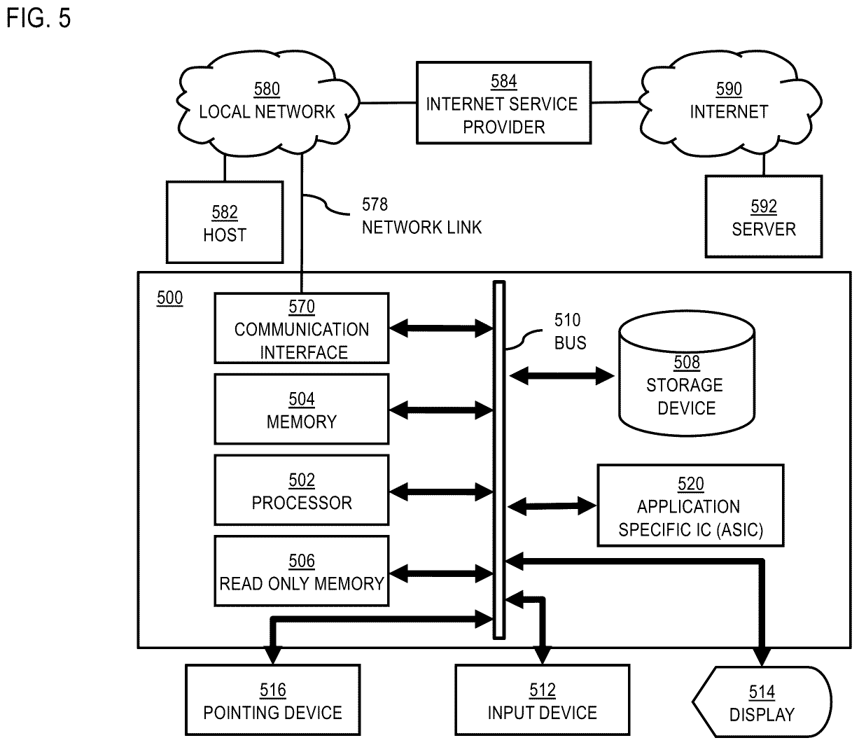

FIG. 5 illustrates a computer system 500 upon which an embodiment of the invention may be implemented. Computer system 500 is programmed (e.g., via computer program code or instructions) to provide automated sporting trophy measurement and scoring as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to providing automated sporting trophy measurement and scoring. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for providing automated sporting trophy measurement and scoring. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing automated sporting trophy measurement and scoring, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general, the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network for providing automated sporting trophy measurement and scoring.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, worldwide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system can be deployed in various configurations within other computer systems, e.g., host 582 and server 592.

FIG. 6 illustrates a chip set 600 upon which an embodiment of the invention may be implemented. Chip set 600 is programmed to provide automated sporting trophy measurement and scoring as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide automated sporting trophy measurement and scoring. The memory 605 also stores the data associated with or generated by the execution of the inventive steps.

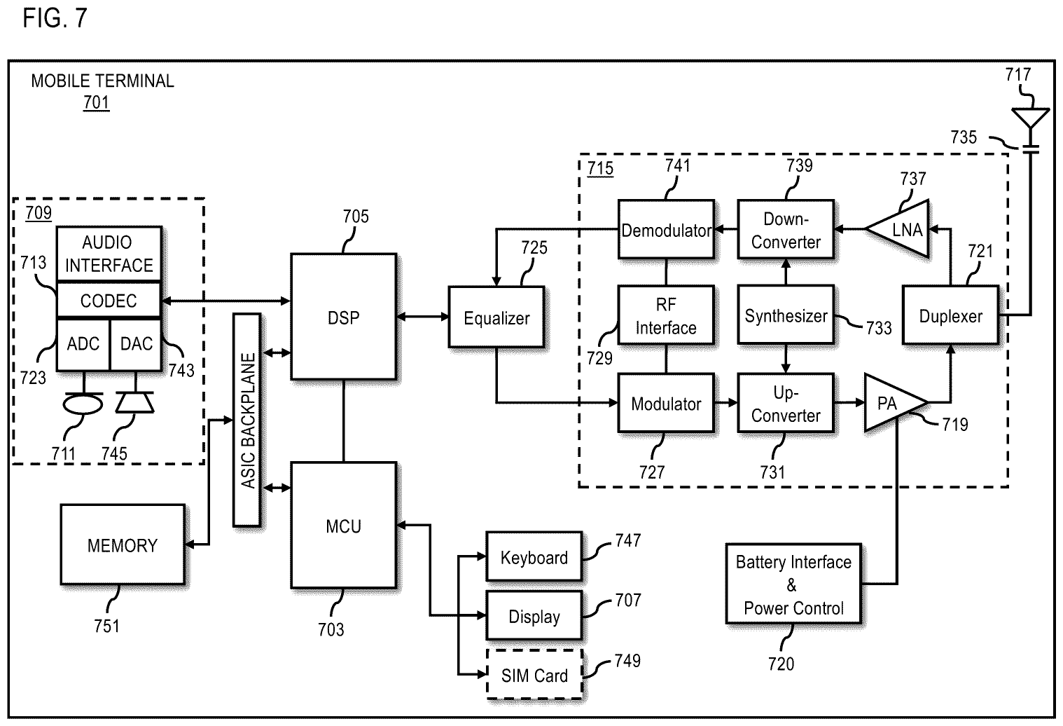

FIG. 7 is a diagram of exemplary components of a mobile terminal (e.g., handset) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions that offer automatic contact matching. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with an RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, another mobile phone or a landline connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile station 701 to provide automated sporting trophy measurement and scoring. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 751 may be, but not limited to, a single memory, CD, DVD, ROM, RAM, EEPROM, optical storage, or any other non-volatile or non-transitory storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method executed by a mobile device comprising a depth sensor, the method comprising:
acquiring, by the depth sensor of the mobile device, sensor data representing a three-dimensional (3D) point cloud of a trophy animal including an animal feature;
detecting, by one or more processors of the mobile device, points of the 3D point cloud corresponding the animal feature;
orienting the animal feature of interest to a designated measurement orientation;
building a model of the animal feature comprising a skeleton graph with nodes and edges;
computing one or more measurements of the animal feature from the model and the point cloud;
computing a score from the one or more measurements on the mobile device without network connectivity; and
presenting a visualization of the score, the one or more measurements, or a combination thereof on a user interface of a display device.

2. The method of claim 1, wherein the animal feature includes antlers.

3. The method of claim 2, wherein the nodes and edges of the skeleton graph represent a main beam and branch tines of the antlers.

4. The method of claim 3, wherein the one or more measurements include one or more width measurements, and wherein the one or more width measurements are determined by computing an inside spread of main beams, a tip-to-tip distance, a widest-point distance, or a combination thereof.

5. The method of claim 2, wherein the antlers are detected by receiving user input identifying one or more burr/base regions of left and/or right antlers and labeling branches as a main beam or a tine based on proximity to the one or more identified burr/base regions.

6. The method of claim 2, wherein the orienting of the animal feature comprises aligning the antlers to a vertical and horizontal axis of a coordinate frame and disambiguating left and right antlers using a curvature-based heuristic.

7. The method of claim 1, wherein the one or more measurements include one or more circumference measurements, and wherein the one or more circumference measurements are determined radially sampling outward from the centerline of the model until a point-density boundary or gradient threshold of the point cloud is reached to estimate an outer surface radius.

8. The method of claim 1, wherein the building of the model comprises constructing a surface mesh from the point cloud.

9. The method of claim 8, wherein the one or more measurements include at least one length measurement, and wherein the at least one length measurement is computed by geodesic pathfinding along an outer surface of the mesh.

10. The method of claim 1, wherein the building of the model comprises generating a graph representation of the point cloud, pruning nodes below a curvature threshold, and computing path lengths along the graph as the length measurements.

11. The method of claim 1, wherein the trophy animal is a fish, and wherein the one or more measurements include a length measurement.

12. The method of claim 11, wherein the length measurement is determined along a surface curvature and a girth at a widest point of the model.

13. The method of claim 1, wherein the depth sensor is a time-of-flight sensor or a LiDAR sensor.

14. A mobile device comprising:
a sensor;
one or more processors; and
a memory storing instructions that, when executed by the one or more processors, cause the device to:
acquire, by the sensor, sensor data representing a three-dimensional (3D) point cloud of a trophy animal including an animal feature;
detect, by the one or more processors, points of the 3D point cloud corresponding the animal feature;
orient the animal feature of interest to a designated measurement orientation;
build a model of the animal feature comprising a skeleton graph with nodes and edges;
compute one or more measurements of the animal feature from the model and the point cloud;
compute a score from the one or more measurements on the mobile device without network connectivity; and
present a visualization of the score, the one or more measurements, or a combination thereof on a user interface of a display device.

15. The mobile device of claim 14, wherein the animal feature includes antlers.

16. The mobile device of claim 15, wherein the nodes and edges of the skeleton graph represent a main beam and branch tines of the antlers.

17. The mobile device of claim 16, wherein the one or more measurements include one or more width measurements, and wherein the one or more width measurements are determined by computing an inside spread of main beams, a tip-to-tip distance, a widest-point distance, or a combination thereof.

18. A non-transitory computer-readable storage medium storing instructions that, when executed by one or more processors of a mobile device comprising a depth sensor, cause the mobile device to perform operations comprising:
acquiring, by the depth sensor of the mobile device, sensor data representing a three-dimensional (3D) point cloud of a trophy animal including an animal feature;
detecting, by one or more processors of the mobile device, points of the 3D point cloud corresponding the animal feature;
orienting the animal feature of interest to a designated measurement orientation;
building a model of the animal feature comprising a skeleton graph with nodes and edges;
computing one or more measurements of the animal feature from the model and the point cloud;
computing a score from the one or more measurements on the mobile device without network connectivity; and
presenting a visualization of the score, the one or more measurements, or a combination thereof on a user interface of a display device.

19. The non-transitory computer-readable storage medium of claim 18, wherein the animal feature includes antlers.

20. The non-transitory computer-readable storage medium of claim 19, wherein the nodes and edges of the skeleton graph represent a main beam and branch tines of the antlers.
